(19) United States
(12) Patent Application Publication
(10) Pub. No.: US 2024/0420042 A1
(43) Pub. Date: Dec. 19, 2024

(54) METHOD AND APPARATUS FOR DISPATCHING UAV INSPECTORS, COMPUTER DEVICE, AND STORAGE MEDIUM

(71) Applicant: 9 REALMS CO., SHENZHEN (CN)

(72) Inventors: KUN LIU, SHENZHEN (CN); XIAOQING WU, SHENZHEN (CN); CHAORAN YANG, SHENZHEN (CN); TIANWU ZANG, SHENZHEN (CN)

(21) Appl. No.: 18/818,602

(22) Filed: Aug. 29, 2024

Related U.S. Application Data
(63) Continuation of application No. PCT/CN2024/107233, filed on Jul. 24, 2024.
(63) Continuation-in-part of application No. 17/537,369, filed on Nov. 29, 2021, now Pat. No. 12,106,376.
Application No. 17/537,369 is a continuation of application No. PCT/CN2020/093388, filed on May 29, 2020.

(30) Foreign Application Priority Data
May 30, 2019 (CN) 201910461185.9

(51) Int. Cl. G06Q 10/0631; G06Q 10/02; G06Q 40/08

(52) U.S. Cl. CPC G06Q 10/063112; G06Q 10/02; G06Q 10/063114; G06Q 40/08

(57) ABSTRACT

The present application provides a method and apparatus for dispatching UAV inspectors, a computer device, and a storage medium. The method includes: receiving order information and obtaining personal data of pilots, wherein a service terminal of an insurance company responds to underwriting or claims request initiated by a target user, obtains order information of the target user and contract information between the insurance company and an inspection party, verifies qualification of the inspection party based on the contract information between the insurance company and the inspection party and basic information of an object to be inspected, and if verification is passed, sends the order information to a server end of the inspection party; performing pilot selection based on the order information and the personal data of pilots to generate dispatch information; sending the dispatch information to a user terminal of a pilot corresponding to the dispatch information.

### CROSS REFERENCE TO RELATED APPLICATIONS

The present disclosure is a U.S. continuation of co-pending International Patent Application Number PCT/CN2024/107233, filed on Jul. 24, 2024, and a U.S. Continuation-in-part of U.S. patent application Ser. No. 17/537,369, filed on Nov. 29, 2021, which is a U.S continuation of co-pending International Patent Application Number PCT/CN2020/093388, filed on May 29, 2020 and claims the benefit and priority of Chinese Patent Application Number 201910461185.9, filed on May 30, 2019. The entire contents of the above-identified applications are incorporated herein by reference.

### TECHNICAL FIELD

The present invention relates to the technical field of artificial intelligence, in particular to a method and apparatus for dispatching UAV (unmanned aerial vehicles) inspectors, a computer device, and a storage medium.

### BACKGROUND

In current housing insurance underwriting and claiming processes, there is a drawback of cumbersome and time-consuming inspection procedures: traditional housing inspections usually require manual inspection by professionals. Especially in inspections relating to roofs, loss adjusters often need to use ladders to climb up to roofs and walk back and forth for 30-75 minutes on the roofs to search for damage points one by one. These processes are time-consuming and laborious, especially in large-scale insurance underwriting and claims, they may lead to low efficiency and increased costs. Due to professionalism of high-altitude operations, in the event of large-scale natural disasters such as hurricanes and hail causing damage to houses in larger areas, the lack of qualified inspectors for timely testing often leads to longer insurance claim cycles.

### SUMMARY OF THE DISCLOSURE

Based on this, aiming at the technical problem of cumbersome and time-consuming inspection procedures existing in insurance underwriting and claiming processes in the prior art, it is necessary to provide a method and apparatus for dispatching UAV inspectors, a computer device, and a storage medium.

In a first aspect, a method for dispatching UAV inspectors is provided, the method comprises: receiving order information and obtaining personal data of pilots, wherein a service terminal of an insurance company responds to underwriting or claims request initiated by a target user, obtains order information of the target user and contract information between the insurance company and an inspection party, verifies qualification of the inspection party based on the contract information between the insurance company and the inspection party and basic information of an object to be inspected, and if verification is passed, sends the order information to a server end of the inspection party; performing pilot selection based on the order information and the personal data of pilots to generate dispatch information; wherein the server end of the inspection party sends the dispatch information to a user terminal of a pilot corresponding to the dispatch information.

In a second aspect, an apparatus for dispatching UAV inspectors is provided, the apparatus comprises: a receiving module configured to receive order information and obtain personal data of pilots, wherein a service terminal of an insurance company responds to underwriting or claims request initiated by a target user, obtains order information of the target user and contract information between the insurance company and an inspection party, verifies qualification of the inspection party based on the contract information between the insurance company and the inspection party and basic information of an object to be inspected, and if verification is passed, sends the order information to a server end of the inspection party; and a selecting and dispatching module configured to perform pilot selection based on the order information and the personal data of pilots to generate dispatch information; wherein the server end of the inspection party sends the dispatch information to a user terminal of a pilot corresponding to the dispatch information.

In a third aspect, a computer device is provided, it comprises a memory, a processor, and a computer program stored in the memory and being capable of running in the processor, and the processor, when executing the computer program, implements the steps of the above method for dispatching UAV inspectors.

In a fourth aspect, a computer readable storage medium is provided, the computer readable storage medium stores a computer program, and the computer program, when being executed by a processor, implements the steps of the above method for dispatching UAV inspectors.

In the method for dispatching UAV inspectors provided by the present invention, order information is received and personal data of pilots is obtained, wherein a service terminal of an insurance company responds to underwriting or claims request initiated by a target user, obtains order information of the target user and contract information between the insurance company and an inspection party, verifies qualification of the inspection party based on the contract information between the insurance company and the inspection party and basic information of an object to be inspected, and if verification is passed, sends the order information to a server end of the inspection party; then pilot selection is performed based on the order information and the personal data of pilots to generate dispatch information; wherein the server end of the inspection party sends the dispatch information to a user terminal of a pilot corresponding to the dispatch information. Inspection efficiency, cost, safety, and user experience during housing insurance underwriting and claiming processes can be significantly improved, and there are obvious technical advantages.

### BRIEF DESCRIPTION OF THE DRAWINGS

In order to explain technical solutions in embodiments of the present invention or in the prior art more clearly, drawings required to be used in description of the embodiments or of the prior art will be briefly introduced below. It is obvious that the drawings in the following description are only some embodiments of the present invention. For one of ordinary skill in the art, other drawings can be further obtained according to these drawings on the premise of paying no creative work.

Among them:

FIG. 1 is an application environment diagram of a method for dispatching UAV inspectors in an embodiment.

FIG. 2 is a flow chart of a method for dispatching UAV inspectors in an embodiment.

FIG. 3 is a structural block diagram of an apparatus for dispatching UAV inspectors in an embodiment.

FIG. 4 is a structural block diagram of a computer device in an embodiment.

FIG. 5 is a structural block diagram of a computer device in another embodiment.

### DETAILED DESCRIPTION

Unless otherwise defined, all technical and scientific terms used in this article have the same meanings as those commonly understood by those skilled in the art belonging to the technical field of the present application. In this article, the terms used in the specification of the present application are only for the purpose of describing specific embodiments and are not intended to limit the present application. The terms “including”, “having”, as well as any variations thereof in the specification, the claims, and the above description of the accompanying drawings of the present application are intended to cover non-exclusive inclusion. The terms “first”, “second”, and the like in the specification and the claims or the accompanying drawings of the present application are intended to distinguish different objects and not to describe a specific order.

Referring to “embodiments” in this article means that specific features, structures, or characteristics described in conjunction with the embodiments may be included in at least one embodiment of the present application. The phrase appearing in various positions in the specification does not necessarily refer to the same embodiment, nor is it an independent or alternative embodiment that is mutually exclusive with other embodiments. Technicians in this field can explicitly and implicitly understand that the embodiments described in this article can be combined with other embodiments.

The technical solutions in the embodiments of the present invention will be described clearly and completely below in combination with the drawings in the embodiments of the present invention. Obviously, the described embodiments are merely some embodiments of the present invention, rather than all embodiments. Based on the embodiments of the present invention, all other embodiments obtained by one of ordinary skill in the art on the premise of paying no creative work belong to the protection scope of the present invention.

A method for dispatching UAV inspectors provided by an embodiment of the present invention can be applied in an application environment as shown in FIG. 1, wherein a client end 110 communicates with a server end 120 through a network. The server end 120 receives order information sent from the client end 110 and obtains personal data of pilots, wherein a service terminal of an insurance company responds to underwriting or claims request initiated by a target user, obtains order information of the target user and contract information between the insurance company and an inspection party, verifies qualification of the inspection party based on the contract information between the insurance company and the inspection party and basic information of an object to be inspected, and if verification is passed, and sends the order information to a server end of the inspection party. Then pilot selection is performed based on the order information and the personal data of pilots to generate dispatch information, wherein the server end of the inspection party sends the dispatch information to a user terminal of a pilot corresponding to the dispatch information. Inspection efficiency, cost, safety, and user experience during housing insurance underwriting and claiming processes can be significantly improved, and there are obvious technical advantages. Among them, the client end 110 can be but is not limited to various personal computers, notebook computers, smartphones, tablets, and portable wearable devices. The server end 120 can be implemented using independent servers or server clusters composed of multiple servers. The user terminals of pilots can be personal computers, notebook computers, smartphones, tablets, and portable wearable devices, which are not limited here. The present invention will be described in detail below through specific embodiments.

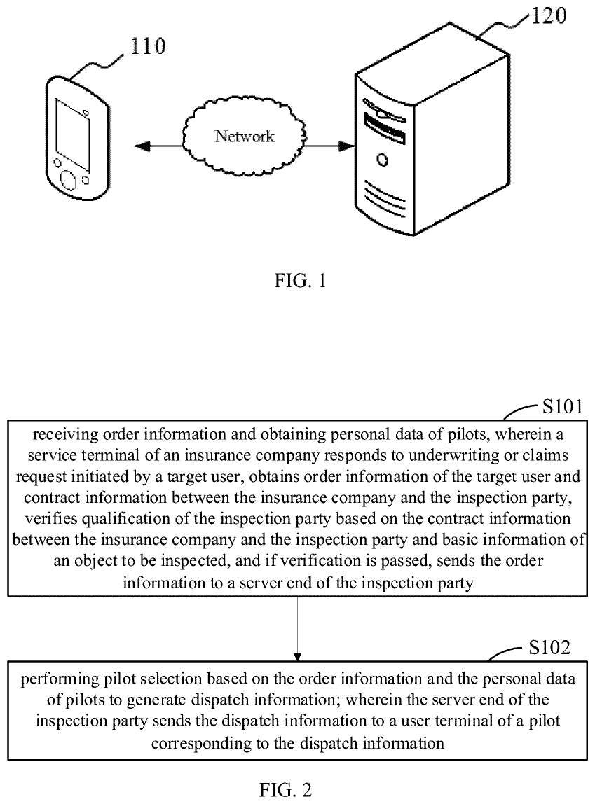

Referring to FIG. 2, FIG. 2 is a schematic flow chart of a method for dispatching UAV inspectors provided by an embodiment of the present invention, which includes the following steps.

Step S101: receiving order information and obtaining personal data of pilots, wherein a service terminal of an insurance company responds to underwriting or claims request initiated by a target user, obtains order information of the target user and contract information between the insurance company and an inspection party, verifies qualification of the inspection party based on the contract information between the insurance company and the inspection party and basic information of an object to be inspected, and if verification is passed, sends the order information to a server end of the inspection party; wherein the pilots refer to unmanned aerial vehicle (UAV) inspectors, and the personal data can include contract information between the inspection party and each contracted pilot, as well as historical inspection data of each pilot, etc.

In this embodiment, the target user can initiate underwriting or claims requests to the insurance company, and the inspection party usually does not participate in this step. The basic information of the object to be inspected can include information such as the type and images of the object to be inspected, whether the object to be objected is located indoors or outdoors, etc. The insurance company determines whether the inspection party has the ability or qualification to inspect the object to be inspected based on the contract information with the inspection party and the basic information of the object to be inspected. If yes, it is considered that the inspection party's qualification verification has been passed. The way for the insurance company to send the order information can be direct contact through phone, email, etc., and can also be creating orders and send requests by API integration of both parties' software platforms.

Step S102: performing pilot selection based on the order information and the personal data of pilots to generate dispatch information; wherein the server end of the inspection party sends the dispatch information to a user terminal of a pilot corresponding to the dispatch information.

In this embodiment, it is possible to select a suitable pilot from various pilots based on the order information and the personal data of pilots, and generate dispatch information. The dispatch information can include a inspection location, inspection time, inspection process information, portrait data of the selected pilot, etc. Then the dispatch information is sent to a user terminal of the selected pilot for the pilot to perform the inspection task.

In one embodiment, the step of generating dispatch information based on the order information and the personal data of pilots includes:

Step S201, based on contract information between the inspection party and each contracted pilot in the personal data and the basic information of the object to be inspected, verifying inspection qualifications of pilots and taking pilots who have passed the verification as candidate pilots.

Among them, the contract information between the inspection party and each contracted pilot include information of inspection qualification of the pilot, the information of inspection qualification includes whether there is qualification for underwriting inspection, whether there is qualification for conducting loss assessment inspection, whether outdoor inspection can be conducted, whether indoor inspection can be conducted, and so on.

In this embodiment, it is possible to select pilots who can inspect the object to be inspected as the candidate pilots according to the basic information of the object to be inspected.

Step S202: based on historical inspection data in personal data of the candidate pilots and the order information, selecting a target pilot in the candidate pilots, and generating dispatch information corresponding to the target pilot.

In this embodiment, historical inspection data in the personal data of the candidate pilots can be firstly obtained, the historical inspection data can include historical user ratings, years of work experience, completed amount of inspection tasks, types of inspected objects in inspection tasks, etc. Based on the historical inspection data and the order information, a target pilot is selected in the candidate pilots, and dispatch information corresponding to the target pilot is generated. For example, based on the type of the object to be inspected in the order information and amount of cases in which pilots inspect objects to be inspected in this type in the historical inspection data, a candidate pilot with high proficiency is determined as the target pilot; it can be considered that the more the amount of cases in which the pilot inspect objects to be inspected in this type, the higher the proficiency.

In one embodiment, the step of based on historical inspection data in personal data of the candidate pilots and the order information, selecting a target pilot in the candidate pilots, and generating dispatch information corresponding to the target pilot includes:
Step S301, obtaining a type of the object to be inspected in the order information;
Step S302, based on the type of the object to be inspected, the historical inspection data of the candidate pilots, and the order information, selecting a target pilot in the candidate pilots, and generating dispatch information corresponding to the target pilot.

For example, the type of the object to be inspected in the order information can be first determined; if the type of the object to be inspected is non-indoor inspected object, it means that there may be no need to make an appointment with a homeowner, which is usually applicable to orders that only require outdoor inspection and not indoor inspection. For example, when the type of the object to be inspected is indoor inspected object, based on the historical inspection data of the candidate pilots and the order information, a target pilot is selected in the candidate pilots, and dispatch information corresponding to the target pilot is generated. Of course, it is also possible to determine a candidate pilot with high proficiency as the target pilot based on the type of the object to be inspected in the order information and amount of cases in which pilots inspect objects to be inspected in this type in the historical inspection data, and it is defaulted that the more the amount of cases, the higher the proficiency.

In one embodiment, the step of based on the type of the object to be inspected, the historical inspection data of the candidate pilots, and the order information, selecting a target pilot in the candidate pilots, and generating dispatch information corresponding to the target pilot includes:
Step S401: sending a reservation link to a user terminal of the target user;
Step S402: when receiving reservation information returned by the user terminal of the target user based on the reservation link, based on the reservation information, the type of the object to be inspected, the historical inspection data of the candidate pilots, and the order information, selecting a target pilot in the candidate pilots, and generating dispatch information corresponding to the target pilot.

As an example, the reservation information includes information such as reservation time, location, contact manners, etc; based on the time and the location in the reservation information, the candidate pilots are selected; afterwards, based on the type of the object to be inspected, the historical inspection data of the candidate pilots, and the order information, the target pilot is determined in the selected candidate pilots, and the dispatch information corresponding to the target pilot is generated.

In one embodiment, after the step of sending a reservation link to a user terminal of the target user, the following step is further included:

Step S501: if no reservation information returned by the user terminal of the target user based on the reservation link is received in a preset period, executing manual reservation.

Among them, the method of manual reservation can be that an operator directly contacts a household head through phone, SMS, email, or other methods to perform address and identity verification and questionnaire filling for information required by an insurance company.

In one embodiment, the step of based on the reservation information, the type of the object to be inspected, the historical inspection data of the candidate pilots, and the order information, selecting a target pilot in the candidate pilots, and generating dispatch information corresponding to the target pilot includes:
Step S601: obtaining current working states of the candidate pilots, wherein the working states include whether the pilots' states are active, whether they are on leave, whether there are task conflicts, order quantities, and idle time periods;
Step S602: based on the reservation information, the type of the object to be inspected, the historical inspection data and the working states of the candidate pilots, and the order information, selecting a target pilot in the candidate pilots, and generating dispatch information corresponding to the target pilot.

As an example, the candidate pilots are selected based on the working states to obtain selected candidate pilots. It should be noted that candidate pilots who are active, have no leave requests, and do not have task conflicts are selected with priority, afterwards, through the type of the object to be inspected, the historical inspection data and the working states of the candidate pilots, and the order information, the target pilot is selected from the selected candidate pilots, and the dispatch information corresponding to the target pilot is generated.

In one embodiment, the step of based on the reservation information, the type of the object to be inspected, the historical inspection data and the working states of the candidate pilots, and the order information, selecting a target pilot in the candidate pilots, and generating dispatch information corresponding to the target pilot includes:

Step S701: based on the working states and the type of the object to be inspected, selecting the candidate pilots to obtain selected candidate pilots.

As an example, based on the working states and the type of the object to be inspected, the candidate pilots are selected to obtain selected candidate pilots. It should be noted that candidate pilots who are active, have no leave requests, and do not have task conflicts, and candidate pilots who have handled a large number of cases with the same or similar types of the object to be inspected are selected with priority.

Step S702, based on the historical inspection data, sorting the selected candidate pilots to obtain a pilot ranking result.

As an example, the historical inspection data includes multiple kinds of sub-data. The sub-data can be historical user ratings, years of work experience, completion amounts of inspection tasks, and types of inspected objects inspection tasks; the sub-data is pre-configured with different weights, calculation is perforend based on the sub-data and the weights corresponding to the sub-data to obtain scores, and sorting is performed for the selected candidate pilots based on the scores to obtain a pilot ranking result. For example, the historical inspection data includes sub-data A and sub-data B, the sub-data A has a value 100 and a weight 0.1, the sub-data B has a value 200 and a weight 0.2, thus the score is 50.

Step S703: based on the pilot ranking result, the order information, and the reservation information, determining a target pilot, and generating dispatch information corresponding to the target pilot.

As an example, in the pilot ranking result, a preset number of top-sorted candidate pilots are selected, and both the reservation information and the order information are sent to the top-sorted candidate pilots for the candidate pilots to compete for an order; when there is a candidate pilot grabs the order successfully, the candidate pilot who grabs the order successfully is taken as the target pilot, and the dispatch information corresponding to the target pilot is generated.

It should also be noted that the present invention has the following advantages: 1. UAVs are used for house inspection, especially inspection for high-altitude parts such as roofs; compared with traditional methods that require claims officers to manually climb up to roofs for tedious inspections lasting 30-75 minutes, UAV inspection greatly shortens inspection time and improves work efficiency. 2. Cost is reduced. Since the use of UAVs reduces the demand for professional high-altitude workers, more part-time inspectors can also conduct inspections that meet insurance industry standards, thereby reducing labor costs of insurance companies in inspection processes. 3. Security is enhanced. UAV detection avoids the risk of high-altitude operations by claims officers, reduces potential safety hazards, and ensures safer detection processes. 4. Timeliness is improved. In the case of house damage caused by large-scale natural disasters such as hurricanes, hail, etc., UAV detection can quickly dispatch and inspect, overcoming the problem of extended claims cycles due to lack of qualified inspectors and improving timeliness of insurance claims. 5. Flexibility is increased. The inspection process of dispatching a pilot of the present invention is designed flexibly and includes multiple kinds of reservation and dispatch methods, which can quickly adjust and reassign inspection tasks according to actual situations, ensuring smooth progress of inspection work. In conclusion, the present invention, by introducing UAV inspection technology, significantly improves inspection efficiency, cost, safety, and user experience during housing insurance underwriting and claiming processes, and has obvious technical advantages.

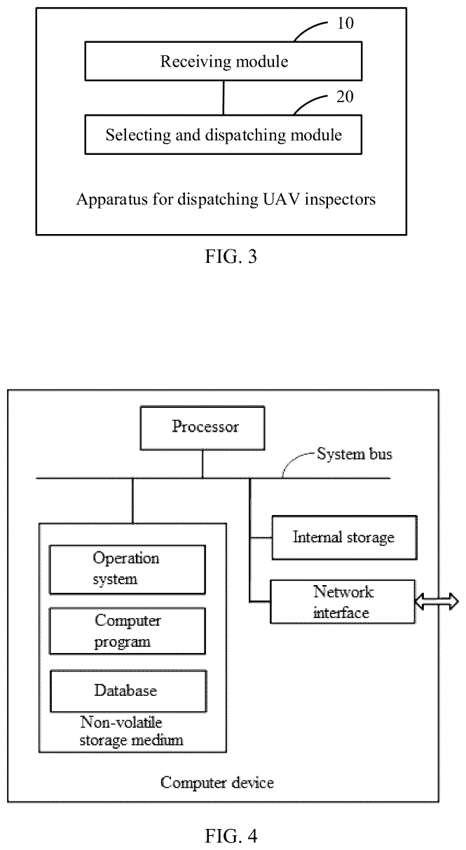

Referring to FIG. 3, in one embodiment, an apparatus for dispatching UAV inspectors is provided. The apparatus includes: a receiving module 10 configured to receive order information and obtain personal data of pilots, wherein a service terminal of an insurance company responds to underwriting or claims request initiated by a target user, obtains order information of the target user and contract information between the insurance company and an inspection party, verifies qualification of the inspection party based on the contract information between the insurance company and the inspection party and basic information of an object to be inspected, and if verification is passed, sends the order information to a server end of the inspection party; and a selecting and dispatching module 20 configured to perform pilot selection based on the order information and the personal data of pilots to generate dispatch information; wherein the server end of the inspection party sends the dispatch information to a user terminal of a pilot corresponding to the dispatch information.

In one embodiment, the selecting and dispatching module 20 is further configured to: based on contract information between the inspection party and each contracted pilot in the personal data and the basic information of the object to be inspected, verify inspection qualifications of pilots and take pilots who have passed the verification as candidate pilots; based on historical inspection data in personal data of the candidate pilots and the order information, select a target pilot in the candidate pilots, and generate dispatch information corresponding to the target pilot.

In one embodiment, the selecting and dispatching module 20 is further configured to: obtain a type of the object to be inspected in the order information; based on the type of the object to be inspected, the historical inspection data of the candidate pilots, and the order information, select a target pilot in the candidate pilots, and generate dispatch information corresponding to the target pilot.

In one embodiment, the selecting and dispatching module 20 is further configured to: send a reservation link to a user terminal of the target user; when receiving reservation information returned by the user terminal of the target user based on the reservation link, based on the reservation information, the type of the object to be inspected, the historical inspection data of the candidate pilots, and the order information, select a target pilot in the candidate pilots, and generate dispatch information corresponding to the target pilot.

In one embodiment, the selecting and dispatching module 20 is further configured to: if no reservation information returned by the user terminal of the target user based on the reservation link is received in a preset period, execute manual reservation.

In one embodiment, the selecting and dispatching module 20 is further configured to: obtain current working states of the candidate pilots, wherein the working states include whether the pilots' states are active, whether they are on leave, whether there are task conflicts, order quantities, and idle time periods; based on the reservation information, the type of the object to be inspected, the historical inspection data and the working states of the candidate pilots, and the order information, select a target pilot in the candidate pilots, and generate dispatch information corresponding to the target pilot.

In one embodiment, the selecting and dispatching module 20 is further configured to: based on the working states and the type of the object to be inspected, select the candidate pilots to obtain selected candidate pilots; based on the historical inspection data, sort the selected candidate pilots to obtain a pilot ranking result; based on the pilot ranking result, the order information, and the reservation information, determine a target pilot, and generate dispatch information corresponding to the target pilot.

In an embodiment, a computer device is provided, the computer device can be a server end, its internal structural diagram can be as shown in FIG. 4. The computer device includes a processor, a memory, a network interface, and a database connected through a system bus. Among them, the processor of the computer device is used to provide calculation and control ability. The memory of the computer device includes non-volatile and/or volatile storage media, as well as internal storage. The non-volatile storage medium stores operating systems, computer programs, and the database. The internal storage provides an environment for operation of the operating systems and the computer programs in the non-volatile storage medium. The network interface of the computer device is used to communicate with external client ends through a network connection. The computer programs are executed by the processor to implement functions or steps of a server-side in a method for dispatching UAV inspectors.

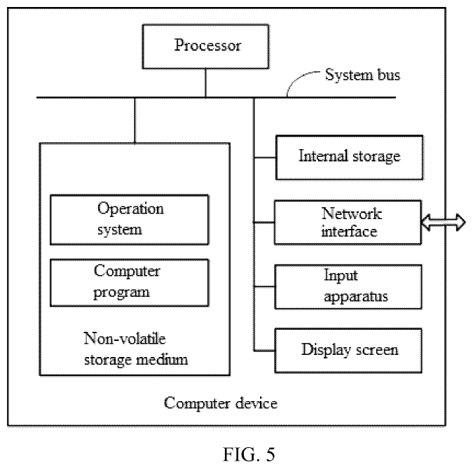

In an embodiment, a computer device is provided, the computer device can be a client end, its internal structural diagram can be as shown in FIG. 5. The computer device includes a processor, a memory, a network interface, a display screen, and an input apparatus connected through a system bus. Among them, the processor of the computer device is used to provide calculation and control ability. The memory of the computer device includes non-volatile and/or volatile storage media, as well as internal storage. The non-volatile storage medium stores operating systems and computer programs. The internal storage provides an environment for operation of the operating systems and the computer programs in the non-volatile storage medium. The network interface of the computer device is used to communicate with external servers through a network connection. The computer programs are executed by the processor to implement functions or steps of a client-side in a method for dispatching UAV inspectors.

In an embodiment, a computer device is provided, it includes a memory, a processor, and a computer program stored in the memory and being executable in the processor; the processor, when executing the computer program, implements the following steps: receiving order information and obtaining personal data of pilots, wherein a service terminal of an insurance company responds to underwriting or claims request initiated by a target user, obtains order information of the target user and contract information between the insurance company and an inspection party, verifies qualification of the inspection party based on the contract information between the insurance company and the inspection party and basic information of an object to be inspected, and if verification is passed, sends the order information to a server end of the inspection party; performing pilot selection based on the order information and the personal data of pilots to generate dispatch information; wherein the server end of the inspection party sends the dispatch information to a user terminal of a pilot corresponding to the dispatch information.

In an embodiment, a computer readable storage medium is provided, the computer readable storage medium stores a computer program; the computer program, when being executed by a processor, implements the following steps: receiving order information and obtaining personal data of pilots, wherein a service terminal of an insurance company responds to underwriting or claims request initiated by a target user, obtains order information of the target user and contract information between the insurance company and an inspection party, verifies qualification of the inspection party based on the contract information between the insurance company and the inspection party and basic information of an object to be inspected, and if verification is passed, sends the order information to a server end of the inspection party; performing pilot selection based on the order information and the personal data of pilots to generate dispatch information; wherein the server end of the inspection party sends the dispatch information to a user terminal of a pilot corresponding to the dispatch information.

It should be noted that the functions or steps that can be implemented by the computer-readable storage medium or the computer device mentioned above can be correspondingly referred to relevant descriptions of the server-side and client-side in the aforementioned method embodiments. In order to avoid repetition, they will not be described one by one here.

Ordinary technical personnel in this field can understand that implementation of all or some of the processes in the methods of the above embodiments can be accomplished by instructing relevant hardware using a computer program. The computer program can be stored in a non-volatile computer-readable storage medium, and when the computer program is executed, it may include the processes of the embodiments of the above methods. Among them, any reference to memories, storages, databases or other media used in the embodiments provided by the present application may include non-volatile and/or volatile memories. The non-volatile memories can include read-only memories (ROM), programmable ROM (PROM), electrically programmable ROM (EPROM), electrically erasable programmable ROM (EEPROM), or flash memory. The volatile memories can include random access memories (RAM) or external cache memories. As an illustration and not a limitation, RAM can be obtained in various forms, such as static RAM (SRAM), dynamic RAM (DRAM), synchronous DRAM (SDRAM), double data rate SDRAM (DDRSDRAM), enhanced SDRAM (ESDRAM), synchronous link (Synchlink) DRAM (SLDRAM), rambus direct RAM (RDRAM), direct memory bus dynamic RAM (DRDRAM), memory bus dynamic RAM (RDRAM), etc.

Technicians in the relevant field can clearly understand that, for convenience and simplicity of description, only the division of the above functional units and modules is given as an example to explain. In practical use, the above functions can be assigned to different functional units or modules to accomplish as needed, that is, the internal structure of the apparatus can be divided into different functional units or modules to complete all or some of the functions described above.

The above described embodiments are only used to illustrate the technical solution of the present invention, and not to limit it; although the present invention has been described in detail with reference to the aforementioned embodiments, those of ordinary skill in the art should understand that they can still modify the technical solutions described in the aforementioned embodiments, or equivalently replace some of the technical features therein; these modifications or replacements do not make essences of relevant technical solutions depart from spirits and scopes of the technical solutions of the embodiments of the present invention, and should be all included within the protection scope of the present invention.

What is claimed is:

1. A method for dispatching UAV (unmanned aerial vehicles) inspectors comprising the following steps:
receiving order information and obtaining personal data of pilots, wherein the receiving order information comprises: in response to underwriting or claims request initiated by a target user, obtaining order information of the target user and contract information between an insurance company and an inspection party, verifying qualification of the inspection party based on the contract information between the insurance company and the inspection party and basic information of an object to be inspected; and if verification is passed, sending the order information to a server end of the inspection party;
performing pilot selection based on the order information and the personal data of pilots to generate dispatch information; and
sending the dispatch information to a user terminal of a pilot corresponding to the dispatch information.

2. The method for dispatching UAV inspectors according to claim 1, wherein the step of performing pilot selection based on the order information and the personal data of pilots to generate dispatch information comprises:
based on contract information between the inspection party and each contracted pilot in the personal data and the basic information of the object to be inspected, verifying inspection qualifications of pilots and taking pilots who have passed the verification as candidate pilots.
based on historical inspection data in personal data of the candidate pilots and the order information, selecting a target pilot in the candidate pilots, and generating dispatch information corresponding to the target pilot.

3. The method for dispatching UAV inspectors according to claim 2, wherein the step of based on historical inspection data in personal data of the candidate pilots and the order information, selecting a target pilot in the candidate pilots, and generating dispatch information corresponding to the target pilot comprises:
obtaining a type of the object to be inspected in the order information;
based on the type of the object to be inspected, the historical inspection data of the candidate pilots, and the order information, selecting a target pilot in the candidate pilots, and generating dispatch information corresponding to the target pilot.

4. The method for dispatching UAV inspectors according to claim 3, wherein the step of based on the type of the object to be inspected, the historical inspection data of the candidate pilots, and the order information, selecting a target pilot in the candidate pilots, and generating dispatch information corresponding to the target pilot comprises:
sending a reservation link to a user terminal of the target user;
when receiving reservation information returned by the user terminal of the target user based on the reservation link, based on the reservation information, the type of the object to be inspected, the historical inspection data of the candidate pilots, and the order information, selecting a target pilot in the candidate pilots, and generating dispatch information corresponding to the target pilot.

5. The method for dispatching UAV inspectors according to claim 4, after the step of sending a reservation link to a user terminal of the target user, further comprising:
if no reservation information returned by the user terminal of the target user based on the reservation link is received in a preset period, executing manual reservation.

6. The method for dispatching UAV inspectors according to claim 4, wherein the step of based on the reservation information, the type of the object to be inspected, the historical inspection data of the candidate pilots, and the order information, selecting a target pilot in the candidate pilots, and generating dispatch information corresponding to the target pilot comprises:
obtaining current working states of the candidate pilots, wherein the working states comprise whether the pilots' states are active, whether they are on leave, whether there are task conflicts, order quantities, and idle time periods;
based on the reservation information, the type of the object to be inspected, the historical inspection data and the working states of the candidate pilots, and the order information, selecting a target pilot in the candidate pilots, and generating dispatch information corresponding to the target pilot.

7. The method for dispatching UAV inspectors according to claim 6, wherein the step of based on the reservation information, the type of the object to be inspected, the historical inspection data and the working states of the candidate pilots, and the order information, selecting a target pilot in the candidate pilots, and generating dispatch information corresponding to the target pilot comprises:
based on the working states and the type of the object to be inspected, selecting the candidate pilots to obtain selected candidate pilots;
based on the historical inspection data, sorting the selected candidate pilots to obtain a pilot ranking result;
based on the pilot ranking result, the order information, and the reservation information, determining a target pilot, and generating dispatch information corresponding to the target pilot.

8. An apparatus for dispatching UAV inspectors comprising:
a receiving module configured to receive order information and obtain personal data of pilots, wherein the receiving module comprises:
an obtaining unit configured to: in response to underwriting or claims request initiated by a target user, obtain order information of the target user and contract information between an insurance company and an inspection party;
a verifying unit configured to: verify qualification of the inspection party based on the contract information between the insurance company and the inspection party and basic information of an object to be inspected; and
a sending unit configured to: if verification is passed, send the order information to a server end of the inspection party;
a selecting and dispatching module configured to perform pilot selection based on the order information and the personal data of pilots to generate dispatch information, and send the dispatch information to a user terminal of a pilot corresponding to the dispatch information.

9. A computer device comprising a memory, a processor, and a computer program stored in the memory and being capable of running in the processor, wherein the processor, when executing the computer program, implements the steps of the method for dispatching UAV inspectors according to claim 1.
